(19) United States
(12) Patent Application Publication
(10) Pub. No.: US 2009/0192848 A1
(43) Pub. Date: Jul. 30, 2009

(54) METHOD AND APPARATUS FOR WORKFORCE ASSESSMENT

(76) Inventor: Gerald Rea, Underwood, IN (US)

Correspondence Address: BAKER & DANIELS LLP, 300 NORTH MERIDIAN STREET, SUITE 2700, INDIANAPOLIS, IN, 46204, US

(21) Appl. No.: 12/195,913

(22) Filed: Aug. 21, 2008

Related U.S. Application Data
(60) Provisional application No. 61/050,950, filed on May 6, 2008.
(60) Provisional application No. 61/024,882, filed on Jan. 30, 2008.

(51) Int. Cl. G06Q 10/00; G06F 7/20; G06F 17/30

(52) U.S. Cl. 705/7; 707/4; 707/E17.014

(57) ABSTRACT

A method and system is disclosed to assess the potential workforce for a region. The potential workforce may include an actual workforce of the region and/or a reserve workforce of the region. Members of the reserve workforce may by individuals that are spaced apart from a region and have expressed a willingness to relocate to the region.

### CROSS REFERENCE TO RELATED APPLICATIONS

This application claims the benefit of U.S. Provisional Patent Application Ser. No. 61/024,882, filed Jan. 30, 2008, titled METHOD AND APPARATUS TO LINK MEMBERS OF A GROUP, Docket JORCH-P0001 and U.S. Provisional Patent Application Ser. No. 61/050,950, filed May 6, 2008, titled METHOD AND APPARATUS TO LINK MEMBERS OF A GROUP, Docket JORCH-P0001-05, the disclosures of which are expressly incorporated by reference herein.

### BACKGROUND

The present disclosure relates to methods and apparatus to assess and manage assets and in particular to methods and apparatus to assess and manage workforces.

Many communities, such as rural communities, experience what has been termed a “Brain Drain.” Brain Drain refers to the fact that members of the community once being trained leave in search of better opportunities elsewhere. This is especially prevalent with younger adults which upon being trained in the skills of their chosen vocation, such as graduation from a vocational school or college, look outside of the community to other areas for employment opportunities. Often they possess a mindset from the moment they apply to college that they will not be able to stay close to home. This not only hurts the workforce available for current employers in the community, but also serves as a barrier for new businesses to locate in the community. That said, often people who leave a community for opportunities in line with their training as satisfied with the community and would stay if the opportunities existed locally.

The “Brain Drain” and problems associated with the phenomena is documented throughout the Midwest of United States. Exemplary examples of recent studies include “Brain Drain in Ohio: Observations and Summaries with Particular Reference to Northeastern Ohio”. February, 2006 and “Should I Stay or Should I Go?” Survey of Recent Philadelphia College Graduates. June, 2004.

### SUMMARY

In an exemplary embodiment of the present disclosure, a method is provided to assess a reserve workforce for a region. In one example, an actual workforce for the region is also assessed.

In another exemplary embodiment of the present disclosure, a computer readable medium includes information related to a reserve workforce for a region. In one example, the computer readable medium includes software which based on the information related to the reserve workforce provides an assessment of the reserve workforce.

In a further exemplary embodiment of the present disclosure, an apparatus is provided which for a defined region and a defined skill criteria determines from stored information regarding a reserve workforce an assessment of the reserve workforce which satisfies the skill criteria.

In yet another exemplary embodiment of the present disclosure, a method of assessing a potential workforce is provided. The method comprising the steps of accessing at least one computer readable medium including reserve workforce data regarding a reserve workforce associated with a region; determining based on at least one skill criteria a first portion of the reserve workforce which have skill information that satisfy the at least one skill criteria; and providing an indication regarding the first portion of the reserve workforce. The reserve workforce data including information related to a plurality of individuals spaced apart from the region which have indicated a willingness to relocate to the region. The reserve workforce data including skill information for the plurality of individuals spaced apart from the region which have indicated a willingness to relocate to the region. In one example, the method further comprising the steps of accessing actual workforce data regarding an actual workforce of individuals located in the region, the actual workforce data including skill information for the plurality of individuals located in the region; and determining based on the at least one skill criteria a first portion of the actual workforce which have skill information that satisfy the at least one skill criteria. In a variation thereof, the method further comprises the step of determining for each of the first portion of the actual workforce whether they are currently employed. In another example, the skill information includes degree information for the reserve workforce and the at least one skill criteria includes at least one desired degree, the first portion of the reserve workforce each having degree information which matches the at least one desired degree. In a further example, the reserve workforce includes a plurality of students and the reserve workforce data includes an expected graduation date. In a variation thereof, the skill criteria specifies a future date and at least one desired degree and the reserve workforce data related to the first portion of the reserve workforce indicates that the first portion of the reserve workforce will have the at least one desired degree by the future date. In still another example, the method further comprises the step of communicating at least one incentive to relocate to the region to the first portion of the reserve workforce. In a variation thereof, the at least one incentive is selected from the group of internships, tuition forgiveness programs, and housing/tax abatement programs. In yet another example the region is a political boundary. In a further example, the region is an area within a defined radius of a location. In another example, the plurality of individuals of the reserve workforce have indicated a willingness to relocate to a first region which is one of the region and contained within the region. In a further example, wherein the plurality of individuals of the reserve workforce have indicated a willingness to relocate to a first region, the region being contained within the first region. In still another example, the reserve workforce data further includes desired benefit information, a scale being associated with the desired benefit information which provides an indication of the importance of a desired benefit to a respective individual. In a still further example, the reserve workforce data further includes desired field of work information, a scale being associated with the desired field of work information which provides an indication of the importance of a desired field of work to a respective individual. In a further example, the reserve workforce data further includes desired income information, a scale being associated with the desired income information which provides an indication of the importance of a desired income to a respective individual. In yet another example, the reserve workforce data includes hometown information indicating a hometown for the respective individual and each individual of the first portion of the reserve workforce has a hometown that is within the region.

In still another exemplary embodiment of the present disclosure, a method of assessing a potential workforce is provided. The method comprising the steps of defining a region; defining a skill criteria; and identifying a plurality of individuals spaced apart from the region which have both indicated a willingness to relocate to the region and which satisfy the skill criteria. In an example, the step of identifying a plurality of individuals spaced apart from the region which have both indicated a willingness to relocate to the region and which satisfy the search criteria includes the steps of querying at least one computer database containing information about a population including the plurality of individuals with the region and the skill criteria; and receiving with an output device information related to the plurality of individuals.

In still a further exemplary embodiment of the present disclosure, a method of assessing a potential workforce. The method comprising the steps of identifying a company for one of relocation to and expansion in a region; defining a skill criteria based on the company; identifying a plurality of individuals spaced apart from the region which have both indicated a willingness to relocate to the region and which satisfy the skill criteria, the identification being performed by searching at least one database; contacting the plurality of individuals to obtain from a first portion commitments for relocating to the region based on the company; and communicating an indication of the commitments to the company. In an example, the method further comprises the step of communicating at least one incentive to relocate to the region to the plurality of individuals. In a variation thereof, the at least one incentive is selected from the group of internships, tuition forgiveness programs, and housing/tax abatement programs.

In still another exemplary embodiment of the present disclosure, a computer readable medium is provided. The computer readable medium comprises at least one database including information related to a plurality of individuals and a workforce assessment software which queries the at least one database based on a first region and a skill criteria to identify a first portion of the plurality of individuals which have provided an indication of a willingness to relocate to the first region. The information including hometown information for each of the plurality of individuals and an indication of a willingness to relocate to the hometown for each of the plurality of individuals. In an example, the first portion of the plurality of individuals having hometowns within the first region.

Additional features and advantages of the present invention will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description of the drawings particularly refers to the accompanying figures in which:

FIG. 1 is a representative view of a computer system having access to workforce assessment software and one or more databases;

FIG. 2 is a representative view of an actual workforce of a region and a reserve workforce spaced apart from the region;

FIG. 3 is a representative view of information regarding members of the actual workforce of FIG. 2 stored in one of the one or more databases of FIG. 1;

FIGS. 4 and 5 are a representative view of information regarding members of the reserve workforce of FIG. 2 stored in one of the one or more databases of FIG. 1;

FIG. 6 is a representative view of avenues that information is provided to the one or more databases of FIG. 1;

FIG. 7 is a representative view of a method of the assessment software of FIG. 1 to assess a workforce for a region;

FIG. 8 is a representative view of an actual workforce for a region and a reserve workforce for the region, wherein the region is a political boundary;

FIG. 9 is a representative view of another region which is a collection of areas defined by political boundaries;

FIG. 10 is a representative view of another region which is an area within a given radius of a locality or address; and

FIG. 11 is a presentation of information related to the population from FIG. 2.

### DETAILED DESCRIPTION OF THE DRAWINGS

The embodiments of the invention described herein are not intended to be exhaustive or to limit the invention to the precise forms disclosed. Rather, the embodiments selected for description have been chosen to enable one skilled in the art to practice the invention.

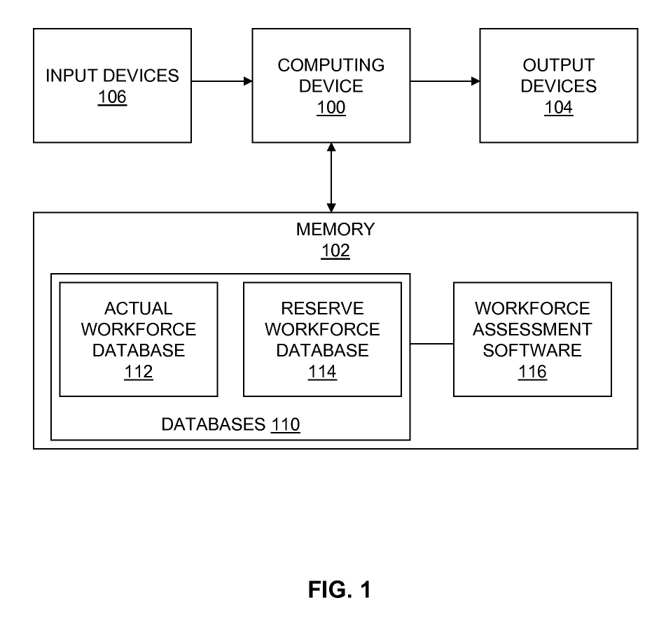

Referring to FIG. 1, a computing device 100 is shown. Computing device 100 may be a general purpose computer or a portable computing device. Although computing device 100 is illustrated as a single computing device, it should be understood that multiple computing devices may be used together, such as over a network or other methods of transferring data. Exemplary computing devices include desktop computers, laptop computers, personal data assistants (“PDA”), such as BLACKBERRY brand devices, cellular devices, tablet computers, or other devices capable of performing the methods disclosed herein.

Computing device 100 has access to a memory 102. Memory 102 is a computer readable medium and may be a single storage device or multiple storage devices, located either locally with computing device 100 or accessible across a network. Computer-readable media may be any available media that can be accessed by the computing device 100 and includes both volatile and non-volatile media. Further, computer readable-media may be one or both of removable and non-removable media. By way of example, and not limitation, computer-readable media may comprise computer storage media. Exemplary computer storage media includes, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which can be used to store information and which can be accessed by the computing device 100.

Computing device 100 has access to one or more output devices 104. Exemplary output devices 104 include fax machines, displays, printers, and files. Files may have various formats. In one embodiment, files are portable document format (PDF) files. In one embodiment, files are formatted for display by an Internet browser, such as Internet Explorer brand browser available from Microsoft Corporation of Redmond, Wash., and may include one or more of HyperText Markup Language (“HTML”), or other formatting instructions. In one embodiment, files are files stored in memory 102 for transmission to another computing device and eventual presentation by another output device or to at least influence information provided by the another output device.

Computing device 100 further has access to one or more input devices 106. Exemplary input devices include a keyboard, a mouse, a roller ball, soft keys, a touch screen, and other suitable devices by which an operator may provide input to computing device 100.

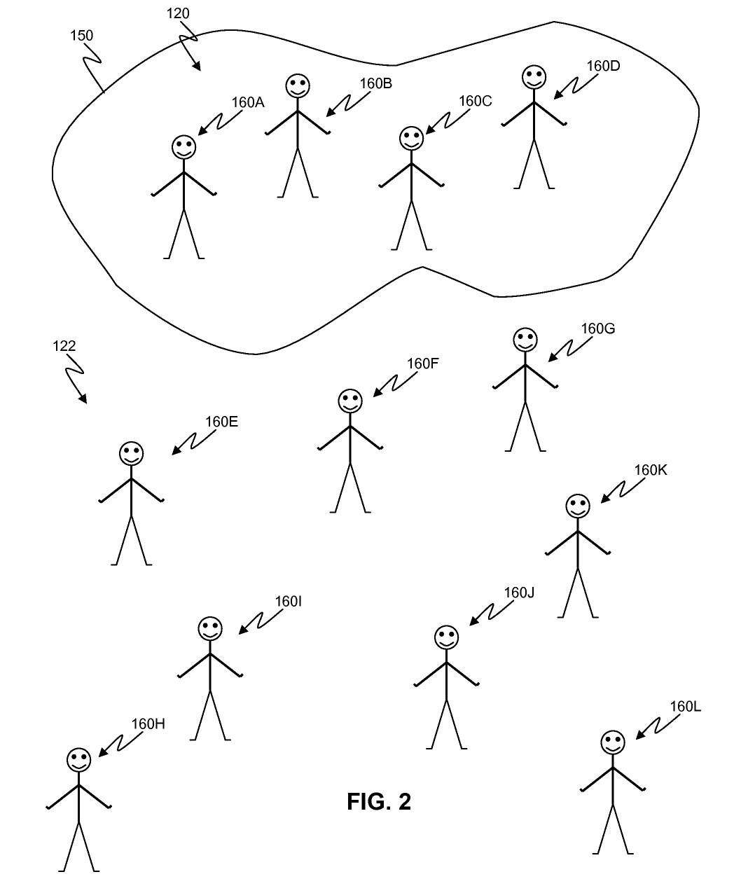

Memory 102 includes one or more workforce databases 110 and workforce assessment software 116. Workforce databases 114 include an actual workforce database 112 and a reserve workforce database 114. Although actual workforce database 112 and reserve workforce database 114 are shown as separate databases, each may be included in the same database. In one embodiment, actual workforce database and reserve workforce database are provided in the same collection of data and are merely descriptive terms to assist in an understanding that based on the definition of region 150 a first portion of the workforce falls within that region 150 and is an actual workforce 120 (see FIG. 2) of the region and a second portion of the workforce is spaced apart from the region 150 and is a reserve workforce 122 (see FIG. 2) of the region 150. As new definitions of region 150 are provided the members of actual workforce 120 and reserve workforce 122 may change. As such, actual workforce database 112 and reserve workforce database 114 are representative of collections of data about an actual workforce 120 and a reserve workforce 122, respectively, and should not be limited to any specific database format. In one embodiment, actual workforce database 112 and reserve workforce database 114 are stored in a MySQL database system available from MySQL AB, a subsidiary of Sun Microsystems Inc, located in Cupertino, Calif.

Workforce assessment software system 116 includes instructions which when executed by computing device 100 present workforce related information based on actual workforce database 112 and/or reserve workforce database 114 to an output device 104. Exemplary information includes an indication of the actual workforce and/or reserve workforce which satisfy a search criteria.

Referring to FIG. 2, a region 150 is shown. Exemplary regions include a city or town, a metropolitan area, a county, a plurality of counties, a state, an area defined by a political boundary, an area defined by geographic boundaries, the area within a given number of miles from a location or address, or any other suitable representation of a region of interest. In one embodiment, a prospective company may desire to define the region as a given county in which the company is considering placing a facility and the surrounding counties.

Region 150 includes a plurality of individuals 160, illustratively individuals 160A-D. Collectively individuals 160A-D may be considered an actual workforce 120 of region 150. In one embodiment, actual workforce 120 includes both an active labor pool which is currently employed and an inactive labor pool which is looking for employment. In one embodiment, actual workforce 120 includes an active labor pool which is currently employed. In one embodiment, actual workforce 120 includes an inactive labor pool which is looking for employment. In one embodiment, actual workforce database 112 has the ability to distinguish a given individual as being a member of the active labor pool and the inactive labor pool.

Outside of or spaced apart from region 150 are a plurality of individuals 160, illustratively individuals 160E-L. Collectively individuals 160E-L may be considered a reserve workforce 122 of region 150. Individuals 160E-L may be located relatively close to region 150 or anywhere around the world. In one embodiment, reserve workforce 122 includes both an active labor pool which is currently employed and an inactive labor pool which is looking for employment. In one embodiment, reserve workforce 122 includes an active labor pool which is currently employed. In one embodiment, reserve workforce 122 includes an inactive labor pool which is looking for employment. In one embodiment, reserve workforce database 114 has the ability to distinguish a given individual as being a member of the active labor pool and the inactive labor pool.

In the example shown in FIG. 2, twelve individuals are used to provide an example of the one use of workforce assessment software 116. In reality, many more individuals 160 are preferably considered.

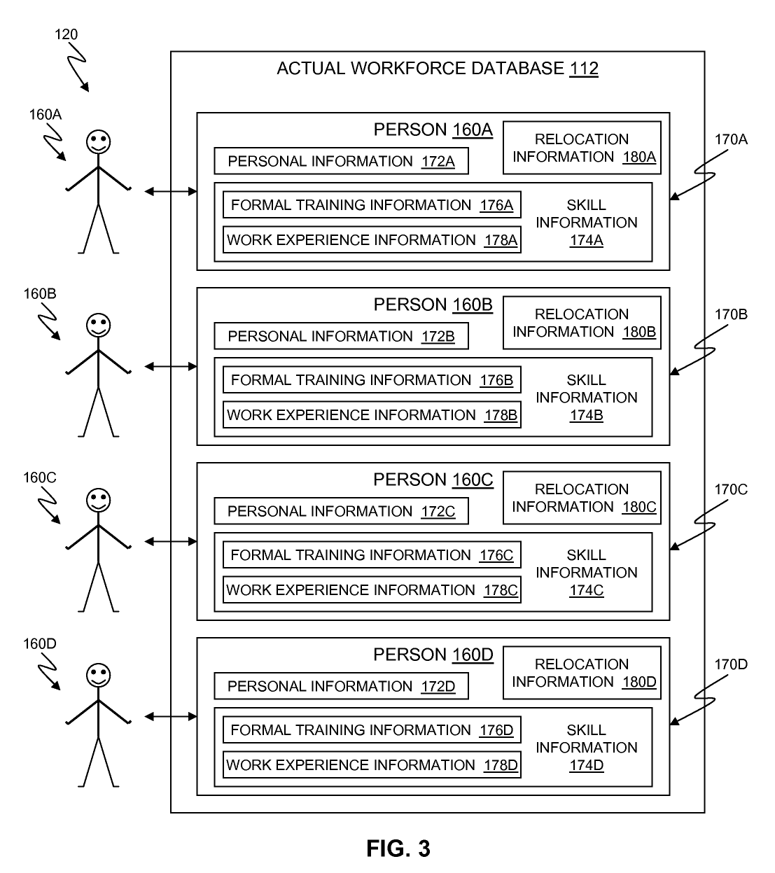

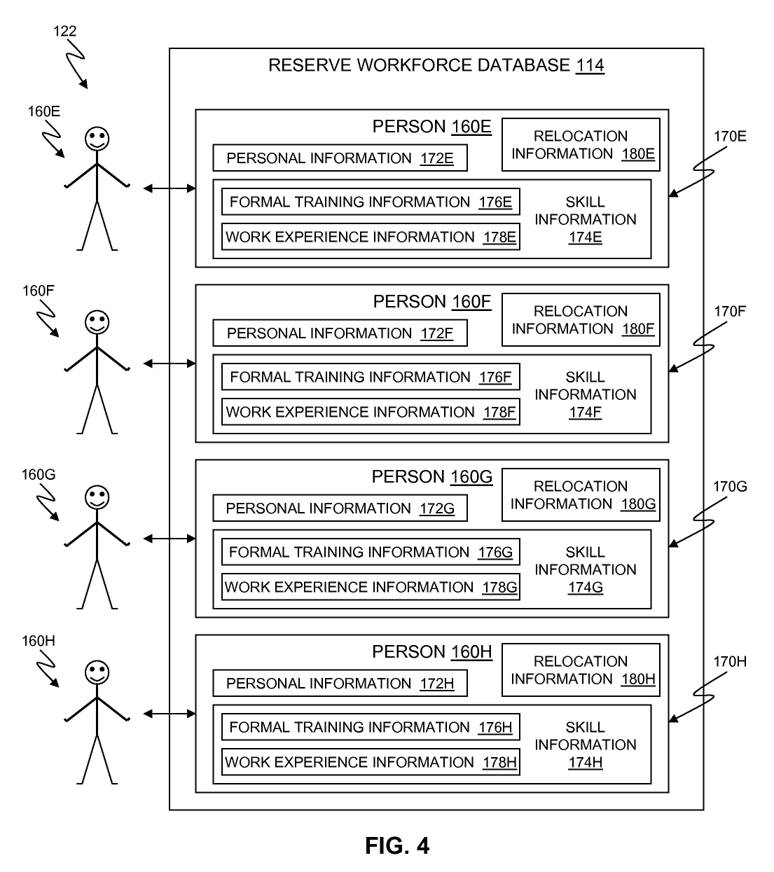

Referring to FIGS. 3-5, each of individuals 160A-L has information 170 related to them stored in the respective one of actual workforce database 112 and reserve workforce database 114 depending on the region. In one embodiment, information 170 includes personal information 172, skill information 174, and relocation information 180. In one embodiment, skill information 174 includes formal training information 176 and work experience information 178.

Exemplary personal information 172 includes name, age, gender, contact information, information regarding income, marital status, dependents, hometown, and other suitable personal information. In one embodiment, the personal information 172 stored in actual workforce database includes the listing in Table I.

TABLE I
Exemplary Personal Information

| Information | Description |
|---|---|
| Name | Name of individual |
| Hometown | Name of locality that the individual |
| | considers their hometown. |
| Gender | Male or Female |
| Marital status | Married, Single |
| Number of Dependents | Number of children, parents providing care |
| | for, and other dependents |
| Ethnicity | Ethic group |
| Contact information | Home address, E-mail, Phone, and other |
| | points of contact |
| Currently Employed | Y/N along with employer information |

Exemplary skill information 174 includes formal training information 176 and work experience information 178. Exemplary formal training information 176 includes whether the individual is currently a student or not, degrees earned, grade point average, standardized test scores, certifications earned, and other information pertaining to formal education the individual is currently seeking (in one embodiment, along with expected date of completion), planning on seeking (in one embodiment, along with expected date of completion), and has completed. In one embodiment, the formal training information 176 stored in the respective one of actual workforce database 112 and reserve workforce database 114 includes the listing in Table II.

TABLE II
Exemplary Formal Training Information

| Information | Description |
|---|---|
| Student | Y/N, degree or certification being sought, |
| | grade point average, standardized test |
| | scores, expected completion date |
| Certifications Earned | Certification, name of school or governing |
| | body, grade point average, standardized test |
| | scores, class rank, honors |
| Degrees Earned | Degree, name of school or governing body, |
| | grade point average, standardized test |
| | scores, class rank, honors |
| Future Planned Degrees | Certification or Degree |
| and/or Certifications | |

Exemplary work experience information 178 includes information regarding current employment (if any) including name of employer, title, responsibilities, software or machinery skilled in interfacing with, and other information related to skills used and responsibilities of current employment. Exemplary work experience information 178 may also include information regarding prior employment(s) (if any) including name of employer, title, responsibilities, software or machinery skilled in interfacing with, and other information related to skills used and responsibilities of the respective prior employment. In one embodiment, the work experience information 178 stored in the respective one of actual workforce database 112 and reserve workforce database 114 includes the listing in Table III.

TABLE III
Exemplary Work Experience Information

| Information | Description |
|---|---|
| Current Employment | Y/N, employer, title, responsibilities, |
| | software or machinery skilled in interfacing |
| | with, references. |
| Past Employment | Y/N, employer, title, responsibilities, |
| | software or machinery skilled in interfacing |
| | with, references. |

In addition, exemplary skill information may include answers to standard questions. For example, a first standard question may be, “What is your strongest job-related selling point?” A second standard question may be, “What is your weakest job-related selling point?” In one embodiment, the answers may be multiple choice answers. For example, choices A: Enjoyable Work, B: Good Pay, C: Enjoyable Work Environment, D: Job Security, E: Job Benefits, and F: Other may be provided as potential responses to the question of “What do you look for most in a job?”

Exemplary relocation information 180 includes desired area(s) to relocate to, fields to work in, desired income, desired benefits, level of interest in relocating to desired area(s), and other suitable information regarding factors in relocating. An exemplary benefit may be relocation costs paid. In one embodiment, the level of interest in relocating to a given area is a binary yes/no (“Y/N”) response. In one embodiment, the level of interest in relocating to a given area is a scale, such as 1 to 10 with 10 being a high willingness to relocate and 1 being a low willingness to relocate. In addition to an overall scale, for a given desired benefit, field of work, and/or desired income, a scale may be associated therewith. For example, an individual may place a high value on a pension program and indicate that with a “10” on an associated scale a high willingness to relocate for an opportunity including a pension program. In one embodiment, the relocation information 180 stored in the respective one of actual workforce database 112 and reserve workforce database 114 includes the listing in Table IV.

TABLE IV
Exemplary Relocation Information

| Information | Description |
|---|---|
| Region interested in | Region (town, city, county, state, or other |
| relocating to | selection) |
| Level of willingness to | Scale of desire to relocate |
| relocate | |
| Desired filed of | Examples: Administration, Biology, |
| employment | Chemistry, Computer Programming, |
| | Customer Service, Driver, Economics, |
| | Education, Engineering, Farming, Finance, |
| | Food Service, Healthcare, Hospitality, |
| | Information Technology, Law, |
| | Management, Manufacturing, Physics, |
| | Public Relations and Communications, |
| | Production, Sales, Science, . . . |
| Desired Income | Income Level |
| Desired Benefit | Benefits |

In one embodiment, the region interested in relocating to is default to the specified hometown of the individual. In this manner, the system is targeting individuals which grew up in a region to return to that region. In one embodiment, the region interested in relocating to may be any region or multiple regions. In this way, the system is targeting individuals which have a desire to relocate to a region that does not include their hometown. For example, a spouse and/or friends of an individual may desire to relocate to a hometown region of that individual. Also, it permits an individual to specify a region that they are interested in to relocate to even if they are not from that region. For example, a given individual may enjoy sailing and have a desire to relocate to Maryland to be able to sail more often.

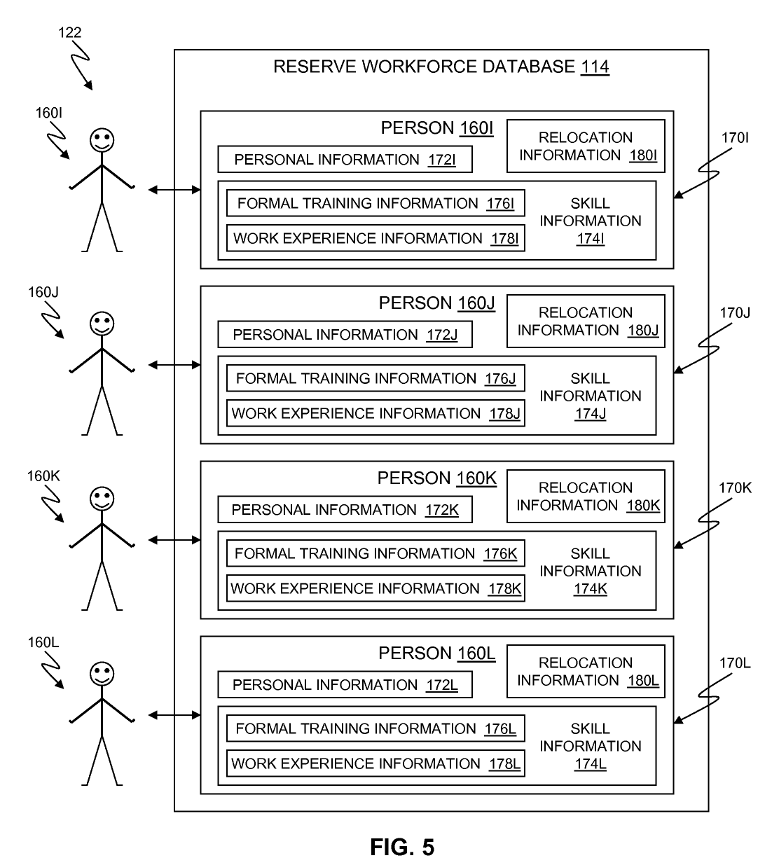

Many avenues exist for populating the information contained in databases 110. Referring to FIG. 6, the information contained in databases 110 may be provided by surveys or questionnaires given at public school sources 200 (such as high schools, vocational schools, colleges, and other types of school), private school sources 202 (such as high schools, vocational schools, colleges, and other types of school), lifelong learning centers 204, web accessible online forums 206, workforce development programs 208, mailings 210. In one embodiment, one or more of the portals discussed in U.S. Provisional Patent Application Ser. No. 61/024,882, filed Jan. 30, 2008, titled METHOD AND APPARATUS TO LINK MEMBERS OF A GROUP, Docket JORCH-P0001, the disclosure of which is expressly incorporated by reference herein, are used to assist in gathering the information.

A company interested in moving to a region may through the databases 110 determine the size and characteristics of both a population currently residing in the region (actual workforce database 112) and the size and/or characteristics of a population willing to relocate to the region if an opportunity existed (reserve workforce database 114). For instance, an economic development director is trying to entice an information technology firm to locate in his town. There are many benefits to the firm such as lower operating costs, but the company does not expect to find the needed workforce. The economic development director uses the reserve workforce database 114 to contact all individuals with the needed skill sets which are currently spaced apart from the region. After he has received commitments from the needed number of individuals to potentially return to the region, the director can entice the company to a location that could not normally support it otherwise. The reserve workforce database 114 opens the lines of communication to former residents who hope to return to their hometown and offers rural communities a way to entice high skill companies to the area. This ability is particularly important to rural communities. In one embodiment, a method of assessing a potential workforce is provided. The method comprising the steps of identifying a company for one of relocation to and expansion in a region; defining a skill criteria based on the company; identifying a plurality of individuals spaced apart from the region which have both indicated a willingness to relocate to the region and which satisfy the skill criteria; contacting the plurality of individuals to obtain from a first portion commitments for relocating to the region based on the company; and communicating an indication of the commitments to the company. The, identification being performed by searching at least one database. In one example, the method further comprises the step of communicating at least one incentive to relocate to the region to the plurality of individuals. Exemplary incentives include internships, tuition forgiveness programs, and housing/tax abatement programs.

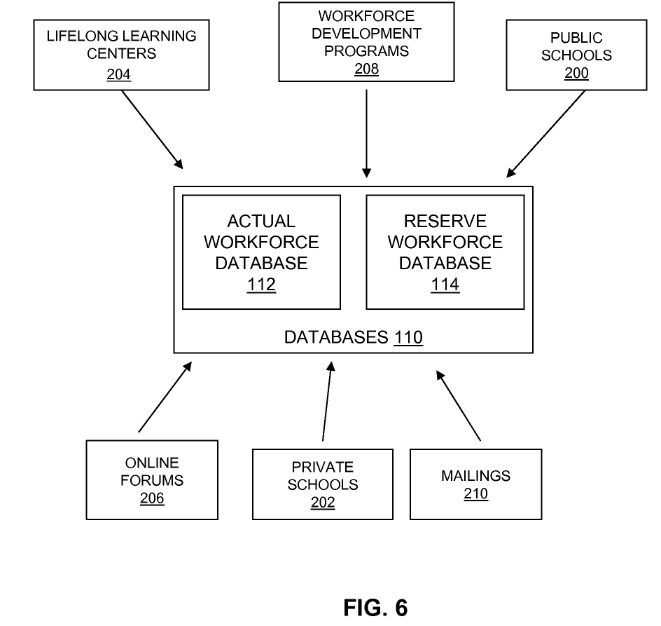

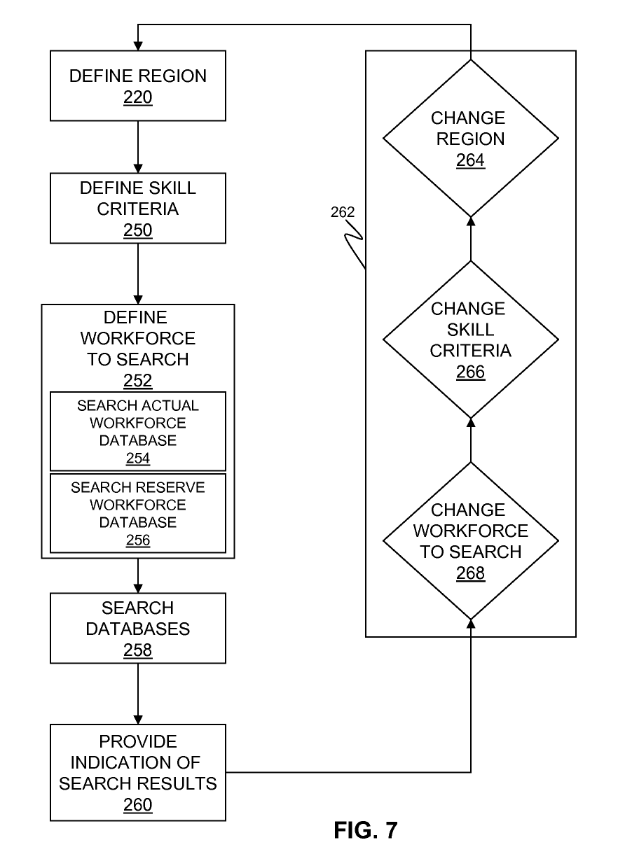

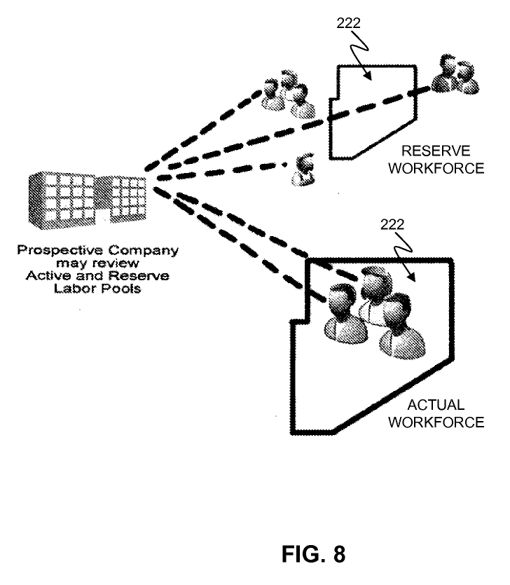

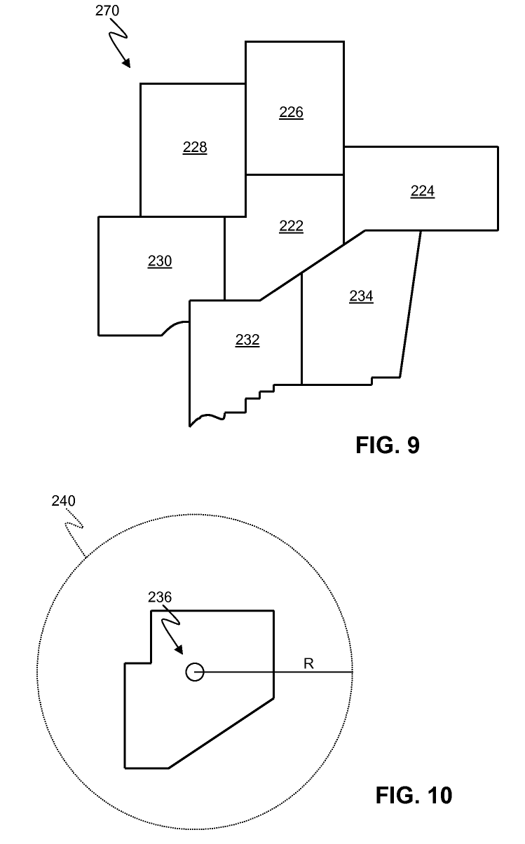

Referring to FIG. 7, an exemplary method of using the information in databases 110 is shown. An operator with workforce assessment software 116 defines a region, as represented by block 220. Referring to FIG. 8, an exemplary region is Decatur County 222 in the state of Indiana. In one embodiment, the operator selects the region with input devices 106 from predefined listing of regions presented by workforce assessment software 116 on a display associated with computing device 100. In one embodiment, the operator is able to select multiple geographical entities presented by workforce assessment software 116 with input devices 106 to define the region. Referring to FIG. 9, another region is shown including multiple geographical entities, illustratively Decatur County 222 and the six surrounding counties 224-234. In one embodiment, the operator is able to define the region in terms of a distance from a locality. Referring to FIG. 10, Decatur County 222 is shown along with its county seat, the city of Greensburg 236. A region 240 is defined as the area within a given radius, r, of Greensburg 236, such as within fifty miles.

Returning to FIG. 7, the operator provides workforce assessment software 116 with a skill criteria 250 to search for in databases 110. Skill criteria 250 may be based on any of the information provided in databases 110. In one embodiment, the search criteria 250 is based on the skill information 174 of databases 110. In the case of an IT company, a skill criteria may be that a qualified individual has a specific degree or one of a plurality of specific degrees. Also, the skill criteria may specify a future date which would coincide to when the IT company is planning on opening operations in the region or expanding operations in the region. The skill criteria then may be that a qualified individual has a specific degree, certification, or work experience at least by that future date.

The operator may then search databases 110 for individuals which match the skill criteria, as represented by block 252. In one embodiment, the operator may limit the search to members of an actual workforce of the region, as represented by block 254. In one embodiment, the operator may limit the search to members of a reserve workforce of the region, as represented by block 256. In one embodiment, the operator may search both for members of an actual workforce of the region and for members of a reserve workforce of the region.

Based on the defined region, the defined skill criteria, and the databases to be searched, workforce assessment software 116 searches the databases to determine individuals which satisfy the search criteria, as represented by block 258. Workforce assessment software 116 then provides an indication of the search results to the operator, as represented by block 260. The indication may be any perceivable method of communicating the search results to the operator. Exemplary methods include displaying the search results on a display (output device 104), storing a file containing the search results, and any other suitable methods of communicating the search results.

The operator may select to refine the search as generally indicated by block 262. The operator may select to change the region, as represented by block 264, to change the skill criteria, as represented by block 266, and/or to change the workforce to include in the search (for example, actual workforce, reserve workforce, or actual workforce and reserve workforce), as represented by block 268. Once the refined search parameters have been set, workforce assessment software 116 again searches the databases, as represented by block 258, and provides an indication of the search results, as represented by block 260.

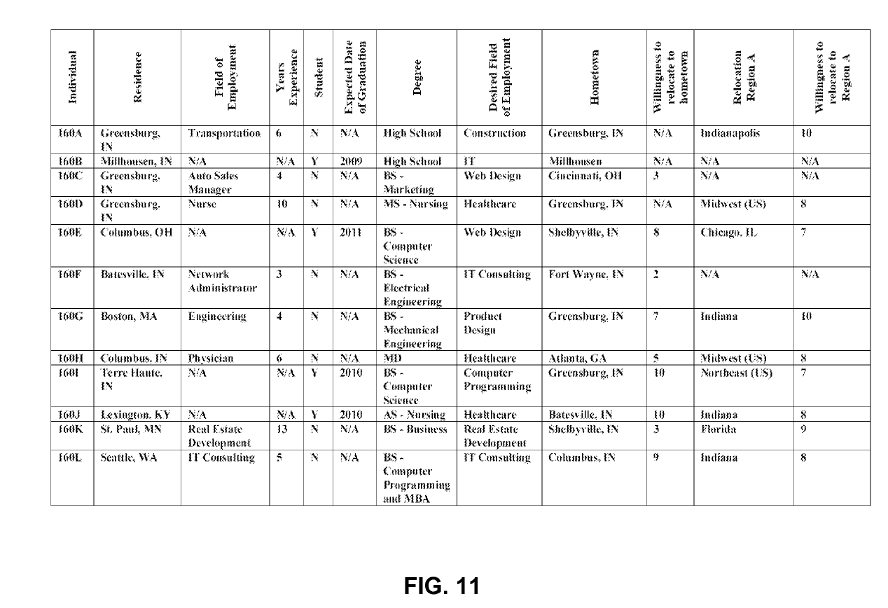

Referring to FIG. 11, an example is given with the twelve individuals 160A-L represented in FIG. 2. Referring to FIG. 11, a portion of the information 170A-L stored in database 110 for each of individuals 160A-L, in one embodiment, is represented. By way of background, the localities of Greensburg and Millhousen are located in Decatur County, Indiana (region 222 in FIG. 9), the locality of Shelbyville is located in Shelby County, Indiana (region 228 in FIG. 9), the locality of Columbus is located in Bartholomew County, Indiana (region 230 in FIG. 9), the locality of Batesville, Indiana is located in Ripley County, Indiana (region 234 in FIG. 9), Terre Haute is located in Vigo County, Indiana (not shown in FIG. 9), Fort Wayne is located in Allen County, Indiana (not shown in FIG. 9), and Indianapolis is located in Marion County, Indiana (not shown in FIG. 9).

Referring to FIG. 9, as an initial use of assessment software 116 an operator in interested in determining the potential workforce for an IT company looking to relocate to Greensburg, Indiana The operator defines the region to be Decatur County, Indiana (region 222).

Based on this selected region 222, individuals 160A-D reside in Decatur County and are considered the actual workforce of region 222. As such, the information regarding individuals 160A-D may be considered an actual workforce database for region 222. In one embodiment, the actual workforce of region 222 is based on the individuals working in Decatur County, irrespective of where the individuals reside.

In one embodiment, based on this selected region, information regarding individuals 160E-L may be considered a reserve workforce database because each of individuals 160E-L are spaced apart from region 222.

In one embodiment, information regarding individuals 160E, 160F, and 160K would not be considered as part of a reserve workforce database because they did not indicate a willingness to relocate to an area that includes region 222. Information regarding individual 160G and individual 160I would be considered as part of a reserve workforce database because they indicated a desire to relocate to their hometown of Greensburg which is within region 222. Information regarding individuals 160H, 160J, and 160L would be considered as part of a reserve workforce database because they indicated a desire to relocate to a region (Midwest, Indiana, Indiana, respectively) which includes region 222.

In one embodiment, information regarding individuals 160E, 160F, and 160K would not be considered as part of a reserve workforce database because they did not indicate a willingness to relocate to an area that includes region 222. Information regarding individual 160G and individual 160I would be considered as part of a reserve workforce database because they indicated a desire to relocate to their hometown of Greensburg which is within region 222. Information regarding individuals 160H, 160J, and 160L would not be considered as part of a reserve workforce database because although they indicated a desire to relocate to a region (Midwest, Indiana, Indiana, respectively) which includes region 222, they did not indicate a desire to relocate to region 222.

In one embodiment, information regarding individual 160G and individual 160I would be considered as part of a reserve workforce database because they indicated a desire to relocate to their hometown of Greensburg which is within region 222. Information regarding individuals 160E, 160F, 160H, and 160J-160L would not be considered as part of a reserve workforce database because they did not specify a willingness to return to a hometown within region 222.

For purposes of discussion, it is assumed that information regarding individual 160G and individual 160I would be considered as part of a reserve workforce database because they indicated a desire to relocate to their hometown of Greensburg which is within region 222 and that information regarding individuals 160H, 160J, and 160L would be considered as part of a reserve workforce database because they indicated a desire to relocate to a region (Midwest, Indiana, Indiana, respectively) which includes region 222. As such, for purposes of discussion the reserve workforce includes individuals 160G-160J and 160L.

In determining the potential workforce for an IT company looking to relocate to Greensburg, Indiana, the operator next defines a skill criteria to search databases 110. One such skill criteria may be that the desired field of employment be a computer related field, that the people are currently out of school, and that they have a college degree. The operator may select to search both the actual workforce for region 222 and the reserve workforce for region 222. Based on these criteria, individuals 160C and 160L would be identified by workforce assessment software 116. Assuming that the IT company was looking for a pool of at least 5 people in order to consider Greensburg a viable option, the operator may adjust one or more of the region and the skill criteria to hopefully increase the number of individuals identified by workforce assessment software 116.

In one example, the operator may redefine the region to be region 270 which is a collection of Decatur County 222, Franklin County 224, Rush County 226, Shelby County 228, Bartholomew County 230, Jennings County 232, and Ripley County 234. With region 270 being the new defined region, individuals 160A-160D, 160F, and 160H are a part of the actual workforce. As such, the information regarding individuals 160A-160D, 160F, and 160H may be considered an actual workforce database for region 222.

Further, the reserve workforce would include 160E, 160G, and 160I-L. Applying the same skill criteria and searching for both members of the actual workforce and the reserve workforce results in individuals 160C, 160F, and 160L being identified by workforce assessment software 116. As such, an additional individual was identified.

The operator may further redefine the search criteria to try to increase the pool to at least five individuals. For example, the operator may know that the company is not looking to have an operational facility until the end of 2011 and is looking for both experienced employees and new hires as well. As such, the operator may define the region as region 270 and alter the skill criteria to be that the desired field of employment be a computer related field, that the people are out of school by 2001, and that they have or will have a college degree. Applying this refined skill criteria and searching for both members of the actual workforce and the reserve workforce results in individuals 160C, 160E, 160F, 160I, and 160L being identified by workforce assessment software 116. As such, two additional individuals were identified for a total of five. Of course, a larger number of individuals are expected to be included in databases 110 and the above examples are provided merely to illustrate exemplary uses of the system.

In one embodiment, members of the reserve workforce may be targeted for incentives associated with the region. The contact information provided in databases 110 may be used to communicate these incentives to at least a portion of the members of the reserve workforce. In one embodiment, the incentives are targeted at members of the reserve workforce which have lived in the region previously or which list a hometown within the region. Exemplary incentives include internships, tuition forgiveness programs, housing/tax abatement programs, or other enticement programs. In one embodiment, one or more of these incentives are offered by a government agency. In one embodiment, one or more of these incentives are offered by a company looking to relocate or expand in the region. In one embodiment, one or more of the incentives are offered by a government agency and/or a company to secure commitments to return to the region.

Although the invention has been described in detail with reference to certain preferred embodiments, variations and modifications exist within the spirit and scope of the invention as described and defined in the following claims.

1. A method of assessing a potential workforce, the method comprising the steps of:
accessing at least one computer readable medium including reserve workforce data regarding a reserve workforce associated with a region, the reserve workforce data including information related to a plurality of individuals spaced apart from the region which have indicated a willingness to relocate to the region, the reserve workforce data including skill information for the plurality of individuals spaced apart from the region which have indicated a willingness to relocate to the region;
determining based on at least one skill criteria a first portion of the reserve workforce which have skill information that satisfy the at least one skill criteria; and
providing an indication regarding the first portion of the reserve workforce.

2. The method of claim 1, further comprising the steps of:
accessing actual workforce data regarding an actual workforce of individuals located in the region, the actual workforce data including skill information for the plurality of individuals located in the region; and
determining based on the at least one skill criteria a first portion of the actual workforce which have skill information that satisfy the at least one skill criteria.

3. The method of claim 2, further comprising the step of determining for each of the first portion of the actual workforce whether they are currently employed.

4. The method of claim 1, wherein the skill information includes degree information for the reserve workforce and the at least one skill criteria includes at least one desired degree, the first portion of the reserve workforce each having degree information which matches the at least one desired degree.

5. The method of claim 1, wherein the reserve workforce includes a plurality of students and the reserve workforce data includes an expected graduation date.

6. The method of claim 5, wherein the skill criteria specifies a future date and at least one desired degree and the reserve workforce data related to the first portion of the reserve workforce indicates that the first portion of the reserve workforce will have the at least one desired degree by the future date.

7. The method of claim 1, further comprising the step of communicating at least one incentive to relocate to the region to the first portion of the reserve workforce.

8. The method of claim 7, wherein the at least one incentive is selected from the group of internships, tuition forgiveness programs, and housing/tax abatement programs.

9. The method of claim 1, wherein the region is a political boundary.

10. The method of claim 1, wherein the region is an area within a defined radius of a location.

11. The method of claim 1, wherein the plurality of individuals of the reserve workforce have indicated a willingness to relocate to a first region which is one of the region and contained within the region.

12. The method of claim 1, wherein the plurality of individuals of the reserve workforce have indicated a willingness to relocate to a first region, the region being contained within the first region.

13. The method of claim 1, wherein the reserve workforce data further includes desired benefit information, a scale being associated with the desired benefit information which provides an indication of the importance of a desired benefit to a respective individual.

14. The method of claim 1, wherein the reserve workforce data further includes desired field of work information, a scale being associated with the desired field of work information which provides an indication of the importance of a desired field of work to a respective individual.

15. The method of claim 1, wherein the reserve workforce data further includes desired income information, a scale being associated with the desired income information which provides an indication of the importance of a desired income to a respective individual.

16. The method of claim 1, wherein the reserve workforce data includes hometown information indicating a hometown for the respective individual and each individual of the first portion of the reserve workforce has a hometown that is within the region.

17. A method of assessing a potential workforce, the method comprising the steps of:
defining a region;
defining a skill criteria; and
identifying a plurality of individuals spaced apart from the region which have both indicated a willingness to relocate to the region and which satisfy the skill criteria.

18. The method of claim 17, wherein the step of identifying a plurality of individuals spaced apart from the region which have both indicated a willingness to relocate to the region and which satisfy the search criteria includes the steps of:
querying at least one computer database containing information about a population including the plurality of individuals with the region and the skill criteria; and
receiving with an output device information related to the plurality of individuals.

19. A method of assessing a potential workforce, the method comprising the steps of:
identifying a company for one of relocation to and expansion in a region;
defining a skill criteria based on the company;
identifying a plurality of individuals spaced apart from the region which have both indicated a willingness to relocate to the region and which satisfy the skill criteria, the identification being performed by searching at least one database;
contacting the plurality of individuals to obtain from a first portion commitments for relocating to the region based on the company; and
communicating an indication of the commitments to the company.

20. The method of claim 19, further comprising the step of communicating at least one incentive to relocate to the region to the plurality of individuals.

21. The method of claim 20, wherein the at least one incentive is selected from the group of internships, tuition forgiveness programs, and housing/tax abatement programs.

22. A computer readable medium, comprising
at least one database including information related to a plurality of individuals, the information including hometown information for each of the plurality of individuals and an indication of a willingness to relocate to the hometown for each of the plurality of individuals; and
a workforce assessment software which queries the at least one database based on a first region and a skill criteria to identify a first portion of the plurality of individuals which have provided an indication of a willingness to relocate to the first region.

23. The computer readable medium of claim 22, the first portion of the plurality of individuals having hometowns within the first region.
